(19) United States
(12) Patent Application Publication
(10) Pub. No.: US 2026/0182768 A1
(43) Pub. Date: Jul. 2, 2026

(54) BEVERAGE BREWING SYSTEM AND METHOD OF DETECTING BEANS WITHIN A BEVERAGE BREWING SYSTEM

(71) Applicant: Haier US Appliance Solutions, Inc., Wilmington, DE (US)

(72) Inventors: Huayi Wang, Shanghai (CN); Zhihua Liu, Louisville, KY (US)

(21) Appl. No.: 18/837,348

(22) PCT Filed: Aug. 16, 2023
(86) PCT No.: PCT/CN2023/113216

§ 371 Date: Aug. 9, 2024

(51) Int. Cl. A47J 31/42; A47J 31/02

(52) U.S. Cl. CPC A47J 31/42; A47J 31/02; A47J 2203/00

(57) ABSTRACT

A beverage brewing system includes a grinding mechanism including a grind motor, a brewing basket module, a current sensor in operable communication with the grind motor, and a controller provided within the housing to perform an operation. The operation includes initiating a grinding at the grind motor, performing a first current measurement via the current sensor at the grind motor at a first time interval, performing a second current measurement via the current sensor at the grind motor at a second time interval, determining that the second current measurement is within a predetermined range of the first current measurement, and implementing a responsive action in response to determining that the second current measurement is within the predetermined range of the first current measurement.

### FIELD OF THE INVENTION

The present subject matter relates generally to beverage brewing systems, and more particularly to methods of operating beverage brewing systems to detect the presence of beans.

### BACKGROUND OF THE INVENTION

Beverage dispensers such as beverage brewing systems perform a range of operations related to preparing and dispensing various beverages on demand to users. Some such beverage dispensers incorporate certain preparation operations, resulting in a multifunctional, all-inclusive beverage machine. For one example, coffee machines include grinders for grinding coffee beans, a water tank for supplying water to the ground coffee, a first heating element to heat the water being supplied to the ground coffee, and a second heating element to provide heat to a container storing the beverage.

Such multifunctional beverage machines may operate automatically. For instance, upon receiving an input from a user to initiate a brewing operation, the beverage machine activates the grinder to grind supplied beans, subsequently supplying the ground beans to a basket. However, certain drawbacks exist to these machines. For instance, the beverage machine may proceed with performing the grinding regardless of whether beans are present within or absent from the grinder. Thus, insufficient brews or potential damage may occur to the machine, leading to consumer dissatisfaction.

Accordingly, a beverage brewing system which obviates one or more of the above-mentioned drawbacks would be beneficial. In particular, a beverage brewing system which accurately detects an absence or lack of beans within a grinder would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a beverage brewing system is provided. The beverage brewing system may include a grinding mechanism for grinding beverage beans, the grinding mechanism including a grind motor; a brewing basket module positioned adjacent to the grinding mechanism to receive bean grounds from the grinding mechanism; a current sensor in operable communication with the grind motor to sense a current output of the grind motor; and a controller operably coupled with the grinding mechanism and the current sensor, the controller being configured to perform an operation. The operation may include initiating a grinding at the grind motor; performing a first current measurement via the current sensor at the grind motor at a first time interval; performing a second current measurement via the current sensor at the grind motor at a second time interval; determining that the second current measurement is within a predetermined range of the first current measurement; and implementing a responsive action in response to determining that the second current measurement is within the predetermined range of the first current measurement.

In another exemplary aspect of the present disclosure, a method of operating a beverage brewing system is provided. The beverage brewing system may include a grind motor, a brewing basket module, and a current sensor in operable communication with the grind motor. The method may include initiating a grinding at the grind motor; performing a first current measurement via the current sensor at the grind motor at a first time interval; performing a second current measurement via the current sensor at the grind motor at a second time interval; determining that the second current measurement is within a predetermined range of the first current measurement; and implementing a responsive action in response to determining that the second current measurement is within the predetermined range of the first current measurement.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a beverage brewing appliance according to exemplary embodiments of the present disclosure.

FIG. 2 provides a side perspective view of the exemplary beverage brewing appliance of FIG. 1.

FIG. 3 provides a side cross-section view of a brewing module according to exemplary embodiments of the present disclosure.

FIG. 4 provides a perspective view of interior components of the beverage brewing appliance of FIG. 1.

FIG. 5 provides a schematic illustration of a network connection between an appliance and a remote user interface device.

FIG. 6 provides a flow chart illustrating a method of operating a beverage brewing appliance.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

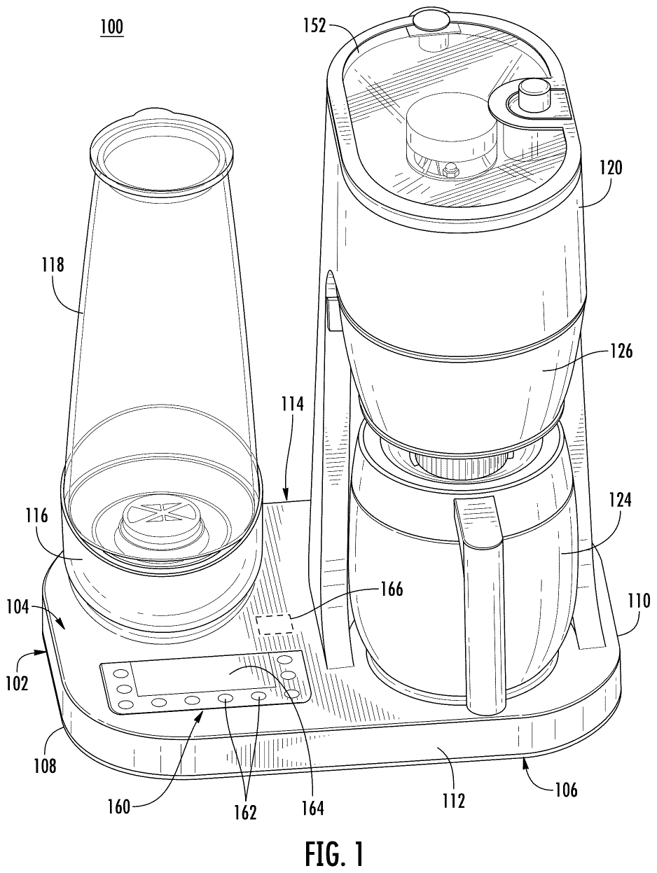

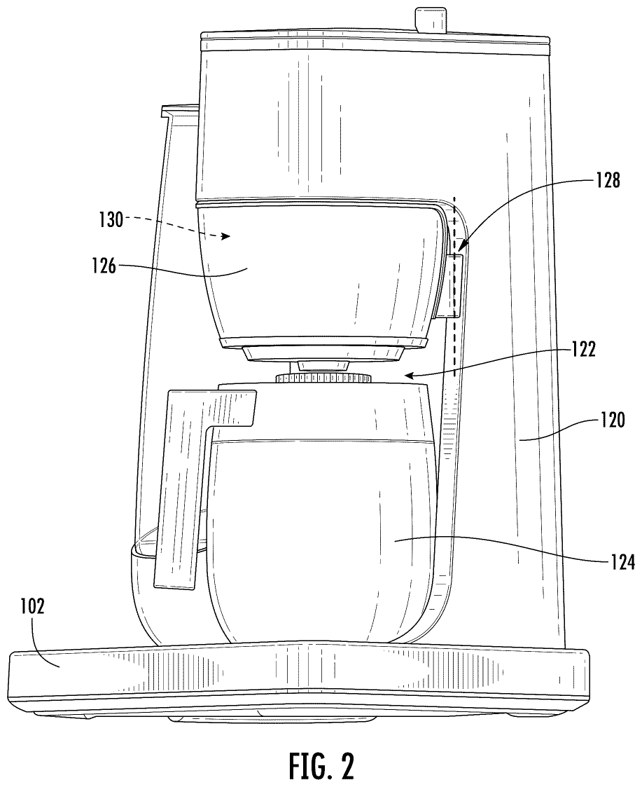

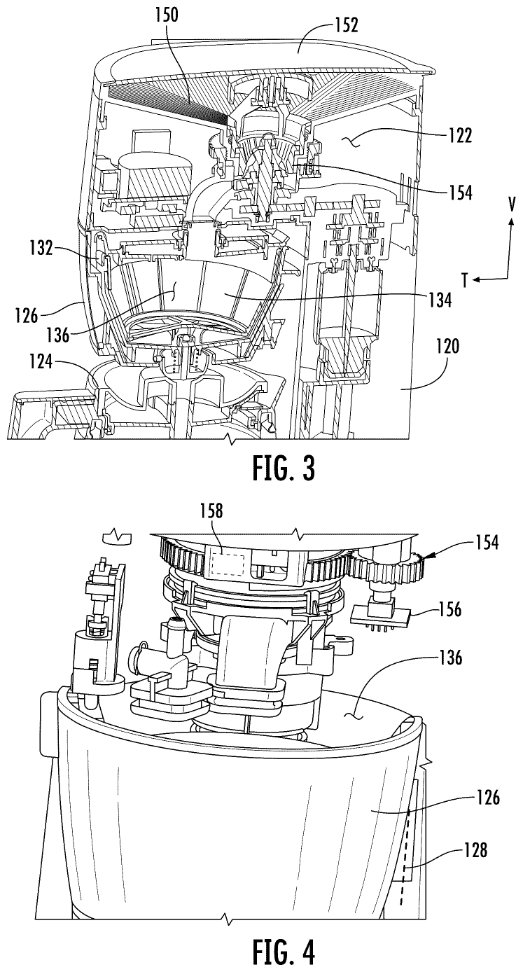

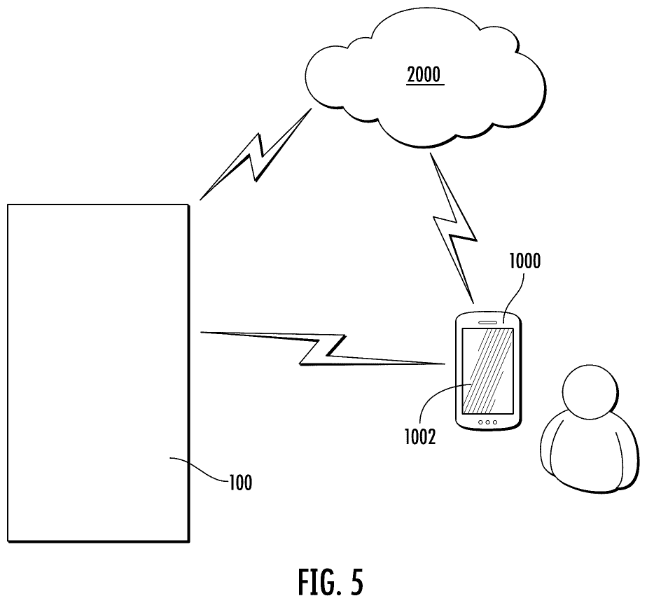

Referring now to the figures, an exemplary appliance will be described in accordance with exemplary aspects of the present subject matter. Specifically, FIG. 1 provides a perspective view of an exemplary appliance (e.g., a beverage brewing system or beverage appliance) 100 and FIG. 2 provides a side view of appliance 100. As illustrated, appliance 100 generally defines a vertical direction V, a lateral direction L, and a transverse direction T, each of which is mutually perpendicular, such that an orthogonal coordinate system is generally defined.

According to exemplary embodiments, appliance 100 includes a cabinet or housing 102 that is generally configured for supporting various components of appliance 100 and which may also define one or more internal chambers or compartments of appliance 100. In this regard, as used herein, the terms “cabinet,” “housing,” and the like are generally intended to refer to an outer frame or support structure for appliance 100, e.g., including any suitable number, type, and configuration of support structures formed from any suitable materials, such as a system of elongated support members, a plurality of interconnected panels, or some combination thereof. It should be appreciated that housing 102 does not necessarily require an enclosure and may simply include an open structure or structures supporting various elements of appliance 100. By contrast, housing 102 may enclose some or all portions of an interior of housing 102. It should be appreciated that housing 102 may have any suitable size, shape, and configuration while remaining within the scope of the present subject matter.

As illustrated, housing 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing appliance 100.

Appliance 100 may include a water tank mounting base 116. Water tank mounting base 116 may extend upward along the vertical direction V from top 104 of housing 102. For instance, water tank mounting base 116 may form a bowl shape into which a water tank 118 may be selectively inserted (or connected) to be used for beverage dispensing. Thus, housing 102 may include one or more passageways (such as tubes, pipes, or the like) in fluid connection with water tank mounting base 116. Water or liquid provided within water tank 118 may flow into the one or more passageways during a brewing or dispensing operation.

Appliance 100 may include a component tower 120. Component tower 120 may extend along the vertical direction V from top 104 of housing 102. Accordingly, component tower 120 may be provided adjacent to water tank mounting base 116. Component tower 120 may define a receiving space 122 for, e.g., a carafe 124. The receiving space 122 may form an alcove into which a beverage container (such as carafe 124) may be positioned to receive a liquid. According to at least one embodiment, a coffee carafe 124 is selectively positioned within receiving space 122 for accepting brewed coffee. Accordingly, receiving space 122 may be formed in part by top 104 of housing 102. Accordingly, a heating element (not shown) may be provided within housing 102. The heating element may thus be at least partially provided within receiving space 122. (e.g., at a bottom portion thereof to support or otherwise direct heat to carafe 124).

Referring still to FIG. 1, appliance 100 may include a control panel 160 that may represent a general-purpose Input/Output (“GPIO”) device or functional block for appliance 100. In some embodiments, control panel 160 may include or be in operative communication with one or more user input devices 162, such as one or more of a variety of digital, analog, electrical, mechanical, or electro-mechanical input devices including rotary dials, control knobs, push buttons, toggle switches, selector switches, and touch pads. Additionally, appliance 100 may include a display 164, such as a digital or analog display device generally configured to provide visual feedback regarding the operation of appliance 100. For example, display 164 may be provided on control panel 160 and may include one or more status lights, screens, or visible indicators. According to exemplary embodiments, user input devices 162 and display 164 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Appliance 100 may further include or be in operative communication with a processing device or a controller 166 that may be generally configured to facilitate appliance operation. In this regard, control panel 160, user input devices 162, and display 164 may be in communication with controller 166 such that controller 166 may receive control inputs from user input devices 162, may display information using display 164, and may otherwise regulate operation of appliance 100. For example, signals generated by controller 166 may operate appliance 100, including any or all system components, subsystems, or interconnected devices, in response to the position of user input devices 162 and other control commands. Control panel 160 and other components of appliance 100 may be in communication with controller 166 via, for example, one or more signal lines or shared communication busses. In this manner, Input/Output (“I/O”) signals may be routed between controller 166 and various operational components of appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 166 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 166 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 166 may be operable to execute programming instructions or micro-control code associated with an operating cycle of appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 166 as disclosed herein is capable of and may be operable to perform any methods, method steps, or portions of methods as disclosed herein. For example, in some embodiments, methods disclosed herein may be embodied in programming instructions stored in the memory and executed by controller 166.

The memory devices may also store data that can be retrieved, manipulated, created, or stored by the one or more processors or portions of controller 166. The data can include, for instance, data to facilitate performance of methods described herein. The data can be stored locally (e.g., on controller 166) in one or more databases and/or may be split up so that the data is stored in multiple locations. In addition, or alternatively, the one or more database(s) can be connected to controller 166 through any suitable network(s), such as through a high bandwidth local area network (LAN) or wide area network (WAN). In this regard, for example, controller 166 may further include a communication module or interface that may be used to communicate with one or more other component(s) of appliance 100, controller 166, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Component tower 120 may include a brewing basket mounting bracket 126. Brewing basket mounting bracket 126 may be rotatably attached to component tower 120. For instance, brewing basket mounting bracket 126 may rotate with respect to component tower 120 along an axis of rotation 128 defined along the vertical direction V. As shown primarily in FIG. 2, axis of rotation 128 may be provided along a lateral edge of component tower 120 (e.g., near second side 110). Brewing basket mounting bracket 126 may be rotatable between a closed position (e.g., accepted within component tower 120) and an open position (e.g., rotated away from component tower 120). Thus, brewing basket mounting bracket 126 may be selectively rotated away from component tower 120 to allow access thereto. Moreover, brewing basket mounting bracket 126 may define a module receiving space 130 therein. Accordingly, at least a portion of brewing basket mounting bracket 126 (and module receiving space 130) is received within component tower 120 in the closed position.

Appliance 100 may include a brewing basket module 132. Brewing basket module 132 may be selectively received within module receiving space 130 of brewing basket mounting bracket 126. For instance, brewing basket module 132 may be accommodated within brewing basket mounting bracket 126 between an inserted position and a removed position.

Brewing basket module 132 may include a basket 134 defining a material receiving space 136. Brewing materials may be selectively supplied within material receiving space 136, such as filters (e.g., coffee filters), coffee grounds, tea leaves, or the like. Basket 134 may have a generally cylindrical shape (or a truncated conical shape), having a central axis defined along the vertical direction V. Other shapes may be incorporated for basket 134, however, and the disclosure is not limited to the examples given herein. For example, basket 134 is shaped complementary to brewing basket mounting bracket 126. Accordingly, brewing basket module 132 may fit easily and securely within brewing basket mounting bracket 126.

Appliance 100 may include a hopper 150. Hopper 150 may be positioned within component tower 120. For instance, hopper 150 may be positioned above brewing basket mounting bracket 126. Hopper 120 may provide a receptacle for certain raw brewing materials (e.g., whole coffee beans). Accordingly, a hopper top 152 may be provided over hopper 150. Hopper 150 may include one or more inclined surfaces 154 creating a funnel toward a center thereof. Accordingly, the raw brewing materials supplied to hopper 150 may be funneled toward a center of hopper 150.

Appliance 100 may include a grinding mechanism 154. Grinding mechanism 154 may be positioned within component tower 120. For instance, grinding mechanism 154 may be positioned between hopper 150 and brewing basket mounting bracket 126. Grinding mechanism 154 may include one or more gears configured to perform a grinding or crushing action on materials supplied thereto. For example, coffee beans placed into hopper 150 are fed to grinding mechanism 154, which in turn grind the coffee beans into a powder (e.g., coffee grounds). The coffee grounds may then be supplied to brewing basket module 132 accommodated within brewing basket mounting bracket 126.

Grinding mechanism 154 may include a grind motor or motor assembly 156. As used herein, “motor” may refer to any suitable drive motor and/or transmission assembly for rotating the grinding mechanism 154. For example, grind motor 156 may include a brushless DC electric motor, a stepper motor, or any other suitable type or configuration of motor. For example, grind motor 156 may include an AC motor, an induction motor, a permanent magnet synchronous motor, or any other suitable type of AC motor. In addition, grind motor 156 may include any suitable transmission assemblies, clutch mechanisms, or other components. According to an exemplary embodiment, grind motor 156 may be operably coupled to a controller (e.g., controller 166), which is programmed to rotate grind mechanism 154 as described herein.

Appliance 100 may include a sensor circuit or sensor 158. For instance, sensor circuit 158 may include one or more sensors positioned within component tower 120. Additionally or alternatively, sensor circuit 158 may be positioned within control panel 160 (or within controller 166). Sensor circuit 158 may include a current sensor configured for detecting, sensing, or measuring a current produced within appliance 100. In detail, sensor 158 may selectively detect a current produced at grind motor 156 over a predetermined time period. For one example, the current sensor is a Hall effect-based sensor. However, it should be understood that any suitable current sensor may be implemented and the disclosure is not limited to the examples provided herein. The predetermined time period may include a plurality of time intervals at which the current is measured. According to at least one example, between around 10 and around 100 time intervals per second are provided at which the current at grind motor 156 is detected.

Sensor circuit 158 may be operably connected with grind motor 156. For example, sensor circuit 158 may be coupled in-line between a power source and grind motor 156, and may also be coupled to controller 166. Sensor circuit 158 may include a shunt resistor, e.g., which may sense or measure electric current to grind motor 156 from the power source. With sensor circuit 158 connected between the power source and grind motor 156 as described, the voltage across the shunt resistor may change as grind motor 156 operates to rotate grinding mechanism 154. Sensor circuit 158 may further include an operational amplifier (“op amp”) and an amplifier connected to the shunt resistor. The voltage across the shunt resistor may be conditioned by the op amp, e.g., in an instrumentation topology, and the conditioned voltage may be amplified by the amplifier, e.g., in a difference amplifier topology. Sensor circuit 158 may further include a separate, dedicated microcontroller (e.g., separate from controller 166), such as a secondary microcontroller which communicates with controller 166. For example, the microcontroller may read the final (conditioned and amplified) voltage after the op amp and the amplifier and communicate such readings to controller 166.

Sensor circuit 158 may include a sine-wave (SW) filter. For instance, the SW filter may be included within the circuitry of sensor circuit 158 (e.g., as a part of an independent controller provided therein). In some embodiments, the SW filter is provided within controller 166 of appliance 100. The current measurements obtained at sensor circuit 158 may be filter through the SW filter to reduce or eliminate noise which otherwise is detrimental to the desired current readings (e.g., such as current pulse, external vibrations, etc.). Accordingly, the finalized (e.g., filtered) results may be presented to an analyzed by controller 166.

FIG. 5 schematically illustrates appliance 100 communicating with a remote user interface device 1000. Also shown (but not numbered) in FIG. 5 is a user such as may interact with remote user interface device 1000, e.g., via a user interface 1002 of the remote user interface such as a touchscreen in the illustrated embodiment. For example, remote user interface device 1000 may be a hand-held device, such as a cell phone or smart phone or any similar device, in operative communication with controller 166 via a wireless connection. As shown in FIG. 5, appliance 100, and in particular, controller 166 thereof, may be configured to communicate with a separate device external to the appliance, such as a communications device or other remote user interface device 1000. Remote user interface device 1000 may be a laptop computer, smartphone, tablet, personal computer, wearable device, smart home system, and/or various other suitable devices. Appliance 100 may include a network communication module, e.g., a wireless communication module, for communicating with remote user interface device 1000. In various embodiments, a network communication module may include a network interface such that controller 166 of appliance 100 can connect to and communicate over one or more networks with one or more network nodes. A network communication module may also include one or more transmitting, receiving, or transceiving components for transmitting/receiving communications with other devices communicatively coupled with appliance 100. The network communication module may be in communication with, e.g., coupled or connected to, controller 166 to transmit signals to and receive signals from the controller 166.

As schematically illustrated in FIG. 5, appliance 100 may be configured to communicate with remote user interface device 1000 either directly or through a network 2000. Thus, in various embodiments, appliance 100 and remote user interface 1000 may be configured to communicate wirelessly with each other and/or with network 2000. Network 2000 may be or include various possible communication connections and interfaces, e.g., such as Zigbee, BLUETOOTH®, WI-FI®, or any other suitable communication connection. Remote user interface device 1000 may include a memory for storing and retrieving programming instructions. For example, remote user interface device 1000 may be a smartphone operable to store and run applications, also known as “apps,” and may include a remote user interface provided as a smartphone app.

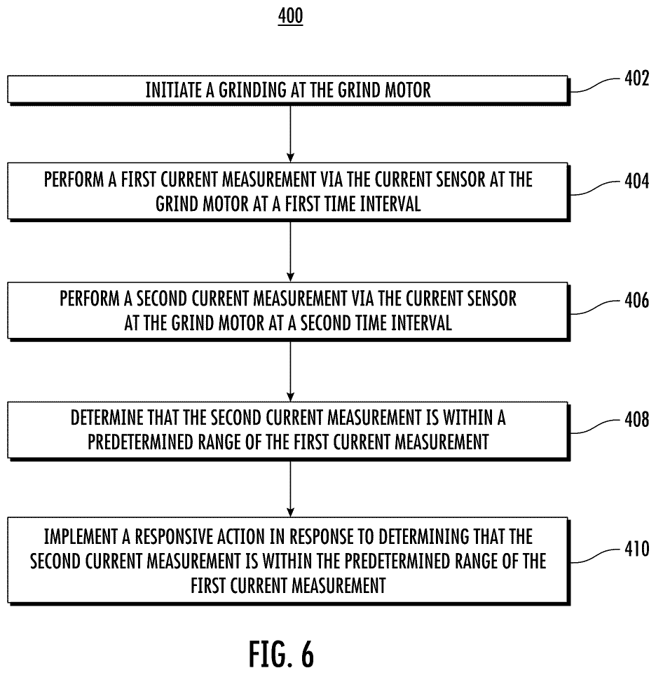

Now that the general descriptions of an exemplary appliance have been described in detail, a method 400 of operating an appliance (e.g., beverage brewing appliance 100) will be described in detail. Although the discussion below refers to the exemplary method 400 of operating appliance 100, one skilled in the art will appreciate that the exemplary method 400 is applicable to any suitable domestic appliance capable of performing a brewing, grinding, and/or roasting operation (e.g., such as a coffee maker, a bean grinder, etc.). In exemplary embodiments, the various method steps as disclosed herein may be performed by controller 166 and/or a separate, dedicated controller. FIG. 6 provides a flow chart illustrating a method of operating a beverage brewing appliance. Hereinafter, method 400 will be described with specific reference to FIG. 6.

At step 402, method 400 may include initiating a grinding at a grind motor. In detail, the appliance may include a grind motor (e.g., grind motor 156). As described above, the grind motor may be configured to provide a rotational force to a grinding mechanism to grind items (e.g., beverage beans such as coffee beans) into a powder or granules (e.g., coffee grounds). The grinding may be initiated by a user. For instance, the user may interact with a user interface (e.g., user input devices 162) to initiate the grinding (or grinding operation). According to some embodiments, the grinding is initiated upon the initiation of a full brewing cycle or operation. For instance, the user may request a cup, mug, or pot of coffee via the user interface at a particular time. Upon receiving the initiation input, the method 400 may activate or initiate the grind motor at a predetermined speed (e.g., in revolutions per minute [RPM]) or power level (e.g., in voltage [V]).

At step 404, method 400 may include performing a first current measurement via a current sensor at the grind motor at a first time interval. For instance, as mentioned above, a sensor (e.g., sensor 158) may be provided in operative communication with the grind motor to measure a current produced thereat. Thus, after initiating the grinding at the grind motor, the method 400 may begin receiving inputs from the sensor at the grind motor. For instance, the first current measurement may be performed within 10 milliseconds after the initiation of the grinding, within 20 milliseconds after the initiation of the grinding, or the like. It should be understood that the ranges provided herein are given by way of example only, and that any suitable time intervals may be incorporated. Thus, the first current measurement may be performed at or immediately after the initiation of the grinding.

In some embodiments, the first current measurement is an average of a plurality of current measurements over a first predetermined period of time. For instance, the method may include performing a plurality of measurements over the first predetermined period of time, which may be between about 100 milliseconds (ms) and about 300 ms. For one example, between about 10 and about 20 individual current measurements are taken over the first predetermined period of time. These 10 to 20 individual measurements may then be averaged together to determine the first current measurement. For instance, a maximum value and a minimum value of these individual measurements may be ignored or otherwise eliminated. Additionally or alternatively, the first current measurement (or each of the 10 to 20 individual measurements) may be filtered through a sine-wave filter. Accordingly and advantageously, unwanted noise from extraneous inputs may be eliminated from the first current measurement.

At step 406, method 400 may include performing a second current measurement via the current sensor at the grind motor at a second time interval. In detail, the method 400 may include performing a plurality of current measurements over a predetermined time period after the grinding is initiated. The second current measurement may thus be performed after the first current measurement (e.g., the second time interval may be after the first time interval). For instance, the first time interval and second time interval may be spaced apart from each other. According to some embodiments, the timing between the first time interval and the second time interval is between about 1 second and about 3 seconds. More particularly, the timing between the first time interval and the second time interval may be between about 100 ms and about 300 ms. It should be noted that any suitable timing difference between the first time interval and the second time interval may be incorporated, and the disclosure is not limited to the examples provided herein.

Similar to the first current measurement, the second current measurement may be an average of a plurality of current measurements over a second predetermined period of time. For instance, the method may include performing a plurality of measurements over the second predetermined period of time, which may be between about 100 ms and about 300 ms. For one example, between about 10 and about 20 individual current measurements are taken over the second predetermined period of time. These 10 to 20 individual measurements may then be averaged together to determine the second current measurement. For instance, a maximum value and a minimum value of these individual measurements may be ignored or otherwise eliminated. Additionally or alternatively, the second current measurement (or each of the 10 to 20 individual measurements) may be filtered through the sine-wave filter. Accordingly and advantageously, unwanted noise from extraneous inputs may be eliminated from the second current measurement.

At step 408, method 400 may include determining that the second current measurement is within a predetermined range of the first current measurement. In detail, after obtaining each of the first and the second current measurements, the method 400 may compare the first current measurement to the second current measurement. Additionally or alternatively, subsequent current measurements may be compared to each other (e.g., a third current measurements to the second current measurements, a fourth current measurement to the third current measurement, etc.). In comparing the first current measurement to the second current measurement, the method 400 may assess the comparison against a predetermined range (e.g., of milliamperes [mA]). For at least one example, the predetermined range is between about 0 mA and about 15 mA. Thus, the method 400 may determined that a difference between the first current measurement and the second current measurement is between 0 mA and 15 mA (or less than 15 mA). It should be understood that the ranged described herein are provided by way of example only, and that any suitable range may be instituted for specific embodiments or applications.

As mentioned above, the first current measurement and the second current measurement may be within a predetermined time period. According to at least some embodiments, the predetermined time period is about one second. Thus, the comparison of the first current measurement and the second current measurement is performed within one second of operation time of the grind motor. Further, as explained below, multiple comparisons may be performed within the predetermined time period. Each successive pair of current measurements may thus be compared to each other to find a difference thereof. For instance, between about 10 and about 100 comparisons may be made within the predetermined time period. Accordingly, erroneous outliers may be ignored among the multiple comparisons. Further, as would be understood, the comparison between the first current measurement and the second current measurement may be outside of the predetermined range (e.g., greater than 15 mA). Accordingly, the method 400 may conclude that the grinding mechanism is successfully grinding beans due to the difference in current measurements.

Further still, steps 406 and 408 may be repeated. For instance, as mentioned above, a third current measurement may be performed subsequent to performing the second current measurement. The third current measurement may be performed similarly to the first current measurement or the second current measurement. Thereafter, the third current measurement (e.g., the obtained average over a third predetermined time period) may be compared to the second current measurement. As would be understood, any suitable number of current measurements may be performed in succession, and subsequent current measurements may be compared against each other to obtain successive differences in the current measurements (e.g., the third current measurement to the second current measurement, a fourth current measurement to the third current measurement, etc.).

At step 410, method 400 may include implementing a responsive action in response to determining that the second current measurement is within the predetermined range of the first current measurement. In detail, the method 400 may analyze one or more comparisons between current measurements, as described above. Step 410 may include determining that each of the comparisons is within the predetermined range. For instance, the comparison between the first current measurement and the second current measurement, the comparison between the second current measurement and the third, the comparison between the third current measurement and the fourth current measurement, and so on, may each fall within the predetermined range. Accordingly, the method 400 may confirm and implement the responsive action.

According to some embodiments, the responsive action includes illuminating a portion of the display. In some embodiments, the illuminated portion of the display may include a message signifying the lack of beans. For instance, upon determining that each of the comparisons is within the predetermined range, the method 400 may conclude that no beans are present within the grinding mechanism. By noting that each current measurement is within the predetermined range (e.g., within 15 mA of each other), the method 400 determines a lack of beans required to produce changes in the current measurements. Accordingly, the method 400 does not rely on a current threshold, instead analyzing a change of current between two or more measurement points. Advantageously, varying currents due to bean size, bean density, air density, adjust vibration, etc. do not alter the method for determining the presence or absence of beans within the grinding mechanism.

Subsequently, the method 400 may determine that there is a lack of beans within the hopper. Additionally or alternatively, the method 400 may determine that any beans within the hopper are restricted from entering the grinding mechanism. Accordingly, the responsive action may include ceasing the grinding (e.g., grinding operation) at the grind motor. Upon determining that no beans are present within the grinding mechanism, the method 400 (e.g., via controller 166) may deactivate or otherwise stop the grind motor, reducing machine fatigue to the grind motor, gears within the grinding mechanism, or the like.

In additional or alternative embodiments, the responsive action includes providing an alert or notification to a user as to the lack of beans via a remote device. For instance, the appliance may be connected to a network (e.g., network 2000) to which a personal device (e.g., remote user interface device 1000) is also connected. As described above, the remote device may include an app providing direct connection to the appliance. Accordingly, the alert may be presented to the user via the app. Additionally or alternatively, the alert may be provided to the user via a “push” notification to immediately alert the user as to the lack of beans within the grinding mechanism. Advantageously, a user which is distant from the appliance may be alerted as to the need for supplying beans to the hopper before the brewing operation commences.

According to the above-described embodiments, an appliance may determine a lack of beverage beans within a grinding mechanism within a short period of time (e.g., less than three seconds, within one second, etc.). Moreover, by comparing consecutive current measurements, the lack of beans may be accurately determined without relying on a single threshold measurement, allowing for a wider range of applicability. Thus, the appliance may be prevented from performing grinding operations on empty hoppers, reducing fatigue on parts and prolonging the life of the appliance. Further still, erroneous brewing operations may be reduced or eliminated, increasing user satisfaction of the appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A beverage brewing system defining a vertical direction, a lateral direction, and a transverse direction, the beverage brewing system comprising:
a grinding mechanism for grinding beverage beans, the grinding mechanism comprising a grind motor;
a brewing basket module positioned adjacent to the grinding mechanism to receive bean grounds from the grinding mechanism;
a current sensor in operable communication with the grind motor to sense a current output of the grind motor; and
a controller operably coupled with the grinding mechanism and the current sensor, the controller being configured to perform an operation, the operation comprising:
initiating a grinding at the grind motor;
performing a first current measurement via the current sensor at the grind motor at a first time interval;
performing a second current measurement via the current sensor at the grind motor at a second time interval;
determining that the second current measurement is within a predetermined range of the first current measurement; and
implementing a responsive action in response to determining that the second current measurement is within the predetermined range of the first current measurement.

2. The beverage brewing system of claim 1, further comprising:
a control panel comprising a display; and
a hopper positioned above the grinding mechanism and configured to supply the beverage beans to the grinding mechanism.

3. The beverage brewing system of claim 2, wherein the responsive action comprises:
illuminating a portion of the display indicating a fill state of the hopper.

4. The beverage brewing system of claim 1, wherein the responsive action comprises:
determining that the beverage beans are absent from the grinding mechanism; and
ceasing the grinding at the grind motor.

5. The beverage brewing system of claim 1, wherein the predetermined range is between 0 milliamps (mA) and 30 mA.

6. The beverage brewing system of claim 1, wherein the first time interval and the second time interval are within 1 second of each other.

7. The beverage brewing system of claim 1, wherein the first current measurement is an average of a first plurality of current measurements over a first period of time and the second current measurement is an average of a second plurality of current measurements over a second period of time.

8. The beverage brewing system of claim 1, wherein each of the first current measurement and the second current measurement is filtered through a sine-wave filter.

9. The beverage brewing system of claim 1, wherein the current sensor is a Hall effect-based sensor.

10. A method of operating a beverage brewing system, the beverage brewing system comprising a grind motor, a brewing basket module, and a current sensor in operable communication with the grind motor, the method comprising:
initiating a grinding at the grind motor;
performing a first current measurement via the current sensor at the grind motor at a first time interval;
performing a second current measurement via the current sensor at the grind motor at a second time interval;
determining that the second current measurement is within a predetermined range of the first current measurement; and
implementing a responsive action in response to determining that the second current measurement is within the predetermined range of the first current measurement.

11. The method of claim 10, wherein the beverage brewing system further comprises:
a grinding mechanism coupled to the grind motor;
a control panel comprising a display; and
a hopper positioned above the grinding mechanism and configured to supply beverage beans to the grinding mechanism.

12. The method of claim 11, wherein the responsive action comprises:
illuminating a portion of the display indicating a fill state of the hopper.

13. The method of claim 10, wherein the responsive action comprises:
determining that no beverage beans are present within a grinding mechanism operably coupled to the grind motor; and
ceasing the grinding at the grind motor.

14. The method of claim 10, wherein the predetermined range is between 0 milliamps (mA) and 30 mA.

15. The method of claim 10, wherein the first time interval and the second time interval are within 1 second of each other.

16. The method of claim 10, wherein the first current measurement is an average of a first plurality of current measurements over a first period of time and the second current measurement is an average of a second plurality of current measurements over a second period of time.

17. The method of claim 10, wherein each of the first current measurement and the second current measurement is filtered through a sine-wave filter.

18. The method of claim 10, wherein the current sensor is a Hall effect-based sensor.
